(19) United States
(12) Patent Application Publication
(10) Pub. No.: US 2014/0266935 A1
(43) Pub. Date: Sep. 18, 2014

(54) MINI FLAT ANTENNA SYSTEM

(71) Applicant: Senseonics, Incorporated, Germantown, MD (US)

(72) Inventor: Szymon Tankiewicz, Germantown, MD (US)

(73) Assignee: Senseonics, Incorporated, Germantown, MD (US)

(21) Appl. No.: 14/212,221

(22) Filed: Mar. 14, 2014

Related U.S. Application Data
(60) Provisional application No. 61/794,183, filed on Mar. 15, 2013.

(51) Int. Cl. H01Q 7/00

(52) U.S. Cl. CPC H01Q 7/00
USPC 343/720; 343/867

(57) ABSTRACT

A system for communicating with a subcutaneous sensor includes a transceiver with a flat antenna. The flat antenna may include a cross section in which the height and the width are not equal. The coils of the antenna may be mounted on a substrate, which may be flexible. The flexible substrate may allow the antenna to conform to the contours of body parts, such as arms, wrists, ankles, legs, or waists.

### CROSS-REFERENCE TO RELATED APPLICATIONS

The present application claims the benefit of priority to U.S. Provisional Application Ser. No. 61/794,183, filed on Mar. 15, 2013, which is incorporated herein by reference in its entirety.

### BACKGROUND

1. Field of the Invention

The present invention relates generally to sensors for implantation within a living animal and detection of an analyte in a medium within the living animal and external transceivers for communicating with the sensors via antenna coils. The present invention also relates to external transceivers having an essentially flat antenna design.

2. Discussion of the Background

A sensor configured to detect an analyte, such as glucose, may be implanted, e.g., subcutaneously, in the body of a living animal, such as a human. The sensor may detect the analyte with florescent indicator molecules that emit an amount of light when irradiated with excitation light as disclosed in co-owned U.S. Pat. No. 7,822,450, the entire disclosure of which is herein incorporated by reference. The sensor may be passive (i.e., powered by an external source) and include an antenna to receive power from an external transceiver. An antenna coil present in the external transceiver may supply energy to the implanted sensor through inductive power transfer (i.e., electromagnetic transmission). The sensor rectifies the power and transfers it to an integrated circuit, which in turn activates a light source (e.g., a light emitting diode (LED)) and digitizes the appropriate response signals. The sensor then transfers the digitized response signals to the transceiver.

An inductively coupled transponder, such as the insertable glucose sensor disclosed in co-owned U.S. Pat. No. 7,553,280, is comprised of an electronic data carrying device, usually a single microchip and a large area coil that functions as an antenna.

The inductively coupled transponder is operated passively. This means that all the energy needed for the operation of the microchip has to be provided by the external transceiver. For this purpose, the transceiver's antenna coil generates a strong, high frequency electro-magnetic field, which penetrates the cross-section of the coil area and the area around the coil. The electro-magnetic field may be treated as a simple magnetic alternating field with regard to the distance between transponder and antenna because the wavelength of the frequency range used, 13.56 MHz, is several times greater than the distance between the transceiver's antenna and the transponder.

The axis of the antenna coil of the sensor is oriented parallel to the skin. Thus, the ideal orientation of the transceiver coil is also to have its axis parallel to the skin (and parallel to the axis of the sensor coil). Unfortunately, a typical cylindrical coil is relatively thick, which means that the transceiver will protrude rather far off the body. This is because a typical coil has a circular cross-section, so that the width and the height are both the same as the diameter of the coil. The transceiver coil is more efficient at transmitting energy if its cross-sectional area is larger, so it is not desirable to simply shrink the height (i.e., the diameter) of the coil. Therefore, a transceiver coil is needed with a large cross-sectional area and a small thickness.

### SUMMARY

One aspect of the present invention may provide a new coil geometry that is essentially oval in shape instead of cylindrical. An antenna coil having the new coil geometry may have a wide width and a short height. The antenna coil may appear to be essentially flat because of the oval-like cross-sectional shape.

The design may provide a flat geometry antenna capable of being placed inside a transceiver (e.g., a wristwatch, armband, waistband, or legband transceiver) communicating with in vivo sensors. In some embodiments, the transceiver may be a flat or slightly curved patch for placement on the abdomen, flank, arm, or leg. The new coil geometry may allow the transceiver to be relatively thin, i.e., the transceiver with an antenna coil having the new geometry may not protrude as far from the surface of the skin as a transceiver with a conventional coil.

A transceiver antenna with the flat antenna design may provide energy to an antenna coil of an implantable sensor sufficient for powering the sensor. The sensor antenna coil may be placed outside the perimeter of the transceiver antenna coil. A typical orientation of the sensor antenna coil to the transceiver antenna coil can be seen in FIG. 1. The sensor antenna coil is within the body and, outside the body, the longitudinal axis of the transceiver antenna coil is approximately parallel to the longitudinal axis of the sensor antenna coil. This orientation is unfavorable from a physics perspective, but it is required because of the constraint of the orientation of the long axis of the sensor. The transceiver antenna system may provide, for example, a 13.56 MHz magnetic field parallel to the sensor antenna main axis, which provides energy to the sensor to operate and communicate by, for example, amplitude modulation (AM) of the field. In comparison with a conventional cylindrical antenna, a flat antenna is beneficial as energy may be transferred more efficiently the closer the transceiver antenna coil is to the sensor antenna coil.

According to one aspect of the present invention, the flat antenna may be made of a metal ferrite material which is rigid. In another aspect, the ferrite may be made from a flexible material, and, as a result, the antenna coil may be flexible. In some embodiments, the flat, flexible antenna may incorporate a flexible ferrite material used in electromagnetic interference (EMI) protection, which replaces the rigid ceramic ferrite substrate. A flexible ferrite material may provide increased flexibility. For example, a flexible antenna in a transceiver may be bent around an arm, wrist, leg, ankle, waist, or other body curvature, making the transceiver more conformal. Also, a flexible antenna may be harder to break than a typical rigid antenna, such as an antenna with a ceramic ferrite substrate. Thus, in some transceiver embodiments including a flexible antenna, the transceiver may not include special protection for the flexible antenna, and there may be fewer limitations on shape and thickness.

The tuning network of an antenna coil determines its resonant frequency. The tuning network typically consists of the inductance of the coil combined with tuning capacitors. In one embodiment, the tuning network may be a set of fixed value components (e.g., capacitors of a fixed value). In another embodiment, the tuning network may be automatically tuned by additional circuitry in the transceiver. For example, the tuning network may include one or more varactors, which may be controlled by a microcontroller or other control means in the transceivers. The varactors in the tuning network of a transceiver antenna coil may allow the transceiver to automatically compensate for any changes in tuning caused by its environment (e.g., being placed on a thicker or thinner wrist, arm, ankle, leg, or waist). In another embodiment, the tuning network may be laser trimmed or otherwise adjustable during production.

In some embodiments, the flat antenna may be lightweight and/or small in size, which may allow the flat antenna to be placed within current transceivers, such as a watch or armband transceiver. Changing the geometry of the coil from a standard cylindrical coil to a flattened design greatly reduces the height of the antenna coil and, therefore, allows the transceiver to be relatively thin as well. A thinner transceiver may be able to obtain more accurate sensor readings because the transceiver may be able to communicate more effectively with a subcutaneous sensor. In other words, the magnetic field of a flat antenna coil may be closer to an implanted sensor than the magnetic field of a conventional cylindrical coil.

In some embodiments, a flat antenna may have a rigid ferromagnetic core or other core material. The flat antenna profile may allow a subcutaneous sensor to be placed in parallel to the main antenna axis at close distance to the antenna of an external transceiver.

In some embodiments, a transceiver may incorporate an electronic system to compensate for antenna tuning changes (e g., tuning changes resulting from changing the antenna curvature due to bending). The transceiver may incorporate a varactor-based or capacitor (array) tuning system to compensate for detuning, which may be a problem with power transmission. Over time, detuning can result in signals that drift outside the sensor's range, causing the antenna to perform below the specifications required to communicate and power the sensor. In some embodiments, the transceiver may include a capacitor array that allows the antenna to “ping” the sensor and determine an optimal frequency range to transmit. In some alternative embodiments, other methods of automatic tuning may be used (e.g., to ensure that a predetermined frequency, such as, for example, 13.56 MHz, is received by the sensor).

A thin flexible antenna embodying aspects of the invention may use a polymer/ferrite substrate. The curvature of a flexible antenna may allow more efficient energy transfer to a subcutaneous sensor. The more efficient energy transfer may require less energy (i.e., a smaller battery), which will in turn increase lifetime of a transceiver battery, allow longer time between recharges, and provide increased sensor reading range. An increased flexibility in material of the antenna may allow the transceiver and the antenna therein to be bent around an arm, wrist, ankle, leg, waist, or other body curvature and, thus, make the transceiver more conformal. Also, a flexible ferrite substrate may not break as easily as a ceramic ferrite substrate, and, as a result, a transceiver having an antenna with a flexible substrate may not need special protection for the antenna. There may be fewer limitations regarding shape and thickness of the antenna. Additionally, ferrite acts as a magnetic amplifier and, thus, may create a stronger signal.

In some embodiments, a flexible antenna may be embedded in an adjustable band, which may fit around an appendage (e.g., wrist, arm, ankle, or leg) or waist. The adjustable and flexible design may direct a majority of the electric field to a subcutaneous sensor allowing for better communication and providing more efficient power to the sensor.

In some embodiments, the transceiver may include an array of smaller antennas. The array configuration of antenna coils may allow for constant communication with a subcutaneous sensor even if the orientation of the sensor has changed within the body since implantation. In some embodiments, electronics within the transceiver may turn on and off the antennas in the antenna array, thus determining which antennas will operate for communication. This configuration may allow for reduced power consumption and/or may correct for altered sensor orientation.

In some embodiments, the transceiver antenna may include bent ends or be shaped as a “U” to focus the magnetic field in the direction of the sensor. Changing the shape of the antenna may allow for electric field focusing on an implanted sensor, thereby creating a more effective power transfer and increasing communication to the sensor.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 is a schematic view of a sensor system, which includes an implantable sensor and a sensor transceiver, known in the art.

FIGS. 2(A) and (B) are a top view and a side view of a transceiver antenna coil with an approximately circular cross-section known in the art.

FIG. 3 is a side view of a flat transceiver antenna coil embodying aspects of the present invention.

FIG. 4 is a top view of a flat transceiver antenna embodying aspects of the present invention.

FIG. 5 is a bottom view of a flat transceiver antenna embodying aspects of the present invention.

FIG. 6 is a perspective view of a flat transceiver antenna embodying aspects of the present invention.

FIG. 7 is a side view of a flat, conformable transceiver antenna embodying aspects of the present invention.

FIG. 8 is a perspective view of a watch transceiver embodying aspects of the present invention.

FIG. 9 is a perspective view of an armband transceiver embodying aspects of the present invention.

FIG. 10 is a perspective view of an array of flat transceiver antennas embodying aspects of the present invention.

FIG. 11 is a perspective view of an armband transceiver including an array of flat transceiver antennas embodying aspects of the present invention.

FIGS. 12(A)-(C) are a top view, a side view and a perspective view of a flat transceiver antenna embodying aspects of the present invention.

FIG. 13 is an exploded perspective view of a transceiver including an antenna embodying aspects of the present invention.

FIG. 14 is a top view of a flat transceiver antenna embodying aspects of the present invention.

### DETAILED DESCRIPTION OF PREFERRED EMBODIMENTS

FIG. 1 is a schematic view of a sensor system 100, which includes an implantable sensor 102 and a sensor transceiver 114, known in the art. The implantable sensor 102 includes an antenna 140, a light source 106, indicator molecules 107, photodetectors 108, and a reference photodetector 110. The implantable sensor 102 receives power and data 118 from the transceiver 114 through the antenna 140, which may be, for example, a coil. The sensor antenna 140 may receive power from the transceiver antenna 112, e.g., through inductive coupling, as represented by the “power and data” arrow 118 and the data arrow 120. The power received by the sensor antenna 140 drives the light source 106, which may be, for example, a light emitting diode (LED) or, possibly, an ulta-violet light emitting diode. The light source 106 emits radiation, including radiation over a wavelength that interacts with the indicator molecules 107. The indicator molecules 107 may be fluorescent indicator molecules or absorption molecules that indicate the presence of an analyte. The photodetectors 108 are sensitive to fluorescent light emitted by the indicator molecules 107 such that a signal is generated by the photodetectors 108 in response thereto that is indicative of the level of fluorescence of the indicator molecules and, thus, the amount of analyte of interest, such as glucose. The photodetectors 108 may be photodiodes, phototransistors, photo resistors or other photosensitive elements, as disclosed in U.S. Pat. No. 7,822,450, which is incorporated by reference herein in its entirety. The antenna 140 transmits data that corresponds to the amount of analyte, as determined by the signal detected by photodetectors 108, to the transceiver 114. Specifically, the sensor antenna 140 transmits the information to the transceiver antenna 112, as represented by the “data” arrow 120.

The sensor antenna 140 and transceiver antenna 112 may be coils. The transceiver antenna 112 may generate an electromagnetic wave or electrodynamic field to induce a current in the sensor antenna 140. The transceiver antenna 112 may also convey commands to the sensor, such as commands for modulating the electromagnetic field used to power the sensor. Moreover, the transceiver antenna 112 may receive information from the sensor 102, for example, by detecting modulations in the electromagnetic field generated by the sensor antenna 140. The sensor antenna 140 and the transceiver antenna 112 may be in any configuration that permits adequate field strength to be achieved when the two coils, or inductive elements, are brought within adequate physical proximity. The closer the physical proximity of the inductive elements the more efficient the transmission of energy and data. The transceiver antenna 112 is more efficient at transmitting energy and data if the cross-sectional area of the coil is large.

FIGS. 2(A)-(B) are a top view and a side view, respectively, of a transceiver antenna 200 comprising a coil with a substantially cylindrical configuration with an approximately circular cross-section, as known in the art. The size of the cross sectional area in cylindrical antennas 200 negatively impacts the physical proximity of the inductive elements to each other because a larger cross section will result in larger height and width of the inductive element. Therefore, the efficiency of cylindrical antennas 200 is limited due to the relationship between the cross sectional area of the coil and the increased height and width (i.e., diameter) of the coil.

FIG. 3 is a cross-sectional view of a flat transceiver antenna coil 300 embodying aspects of the present invention. The flat transceiver antenna 300 may be a coil in which the height and width of the cross section are not equal, which allows for a large cross sectional area and a small height. For example, in one non-limiting embodiment, the flat antenna 300 may have an oval-shaped cross section. However, in other embodiments, other shapes may be used as well, e.g. rectangular, etc. The large cross sectional area of the flat antenna 300 may allow for efficient transfer of energy and data between the flat antenna 300 and a sensor 100. The small height may allow for the flat transceiver antenna 300 and the sensor antenna 140 to be in closer physical proximity to each other than with a typical transceiver antenna 200 with a circular cross section and the same cross-sectional area. In some non-limiting embodiments, the ratio between the width and the height of the flat transceiver antenna may be large, e.g., 2:1, 5:1,10:1, or greater. For instance, in one non-limiting embodiment, the antenna may be as thin as technology allows. In another non-limiting embodiment, as shown in FIG. 3, the ratio of the width to the height may be 17:1. In some non-limiting embodiments, the height of the flat transceiver antenna 300 may be within the range from half the width of the flat transceiver antenna 300 to as short as technology allows, and this range of flat transceiver antenna heights should be understood as describing and disclosing all heights (including all decimal or fractional numbers) within this range.

In some embodiments, the transceiver antenna 300 may provide a magnetic field (e.g., 13.56 MHz magnetic field) parallel to the sensor antenna's main axis. The magnetic field of the transceiver antenna 300 may provide energy to the sensor antenna 140, which allows the sensor 102 to operate, and communicate with the sensor 102 by amplitude modulation (AM) of the field. Conversely, the sensor antenna 140 may transmit data back to the transceiver antenna 300 by AM of the field.

FIGS. 4-7 are views of a flat transceiver antenna 300 embodying aspects of the present invention. The flat antenna 300 may include a substrate 400, a plurality of antenna coils 402, and a spine 404. The plurality of antenna coils 402 and the spine 404 may be mounted on the substrate 400. In one non-limiting embodiment, the spine 404 may be positioned length-wise relative to the antenna 300, and the antenna coils 402 may emanate from the spine 404. In some embodiments of the present invention, the coils 402 may be oriented approximately orthogonal to the spine 402. In some embodiments of the present invention, the coils 402 may be configured such that the length of the coils 402 narrows as they get closer to the spine 402. In these embodiments, the height and width of the coils 402 may remain constant throughout the antenna 300, i.e., only the length of the coils 402 may change. In some embodiments, as shown in FIG. 14, the coils 402 may be wrapped continuously around the substrate 400. The coils 402 may be wrapped around the substrate 400 in any direction including, in a non-limiting example, approximately orthogonal to the orientation shown in FIG. 14.

In some embodiments, the substrate 400 may be rigid and composed of a material such as, for example, metal ferrite. In other embodiments, the substrate 400 may be made from a flexible material, so that the antenna coil is flexible. In some embodiments, the flexible substrate 400 may be composed of, for example, flexible ferrite material used in electromagnetic interference (EMI) protection or a flexible polymer-ferrite. The flexible substrate may be advantageous because the antenna can be bent around an object (e.g., an arm, wrist, waist, or leg) when the antenna is incorporated in a transceiver, and the flexible antenna may not break as easily as like antennas incorporating rigid substrates. Antennas with rigid substrates may require special protection to prevent breakage, and this protection will not be necessary for flexible antennas that are less rigid and brittle. Also, there may be fewer limitations on the shape and thickness of a flexible antenna than a rigid antenna. In some embodiments, the flexible antenna 300 may have more efficient energy transfer to a subcutaneous sensor 100, which may require less energy and longer lifetime for the transceiver power source (see FIG. 13), such as, for example, a battery. Additionally, ferrite acts as a magnetic amplifier, which may create a stronger signal from the antenna 300.

In some embodiments, the transceiver may include an application specific integrated circuit (ASIC) with an electronic system (see FIG. 13) to compensate for tuning changes resulting from changes in curvature due to bending of the flexible antenna 300. The electronic system may incorporate a varactor-based or capacitor (array) tuning system, which may compensate for detuning caused by bending of the flexible antenna 300. As shown in FIG. 7, the flexible antenna 300 can bend to conform to the shape of the transceiver 114. When the flexible antenna 300 bends, the substrate 400 and the antenna coils 402 may both bend and, therefore, may conform to the shape of a body part, e.g., a forearm, wrist, arm, ankle, leg, or waist, on which the transceiver 114 is worn.

For example, in one non-limiting embodiment, the flexible antenna 300 may conform to the shape of a wrist when the transceiver is a watch 800, as shown in FIG. 8, or to the shape of a limb when the transceiver is an arm band 900, as shown in FIG. 9. In the watch transceiver 800, the flat antenna 300 design may allow the antenna 300 to be incorporated into a low profile transceiver, such as in the head 802 of a wrist watch style device 800, or in the watch band 804. When the antenna 300 is housed in the watch band 804 it is configured to conform to the shape of the band 804. In the arm band 900, the antenna 300 may be incorporated, for example, in a main body 902 or in the strap or band portion 904.

FIG. 10 is a perspective view of an array 1000 of flat transceiver antennas 300 embodying aspects of the present invention. The array 1000 may comprise a plurality of antennas 300 positioned adjacent each other. In an embodiment of the present invention, each antenna 300 may be identical to antenna 300 shown in FIGS. 4-6 and may be positioned such that at least one side of the substrate 400 is adjacent and approximately parallel with at least one side of the substrate of an adjacent antenna 300. In some embodiments, as shown in FIG. 10, the array 1000 may comprise a square formation of antennas 300. In a non-limiting embodiment, the array may comprise, for example, three antennas-by-three antennas or four antennas-by-four antennas. In some non-limiting embodiments, the array 1000 may alternatively comprise a rectangular shape, e.g., one antenna-by-three antennas or two antennas-by-four antennas. In some embodiments of the present invention, the antennas 300 in the array 1000 may be smaller in size than antennas 300 used alone in transceivers. This may be beneficial because it allows for the use of more antennas while minimizing the size of the array 1000 and the transceiver 114.

In some embodiments, the configuration of array 1000 of antennas 300 may allow for constant communication with a subcutaneous sensor 102 even if the orientation of the sensor 102 has changed within the body since implantation. Electronics (see, e.g., FIG. 13) within the transceiver 114 may turn the antennas 300 in the array 1000 on and off to determine which antennas 300 are communicating with the sensor 102 most efficiently. In some embodiments, the array 1000 may allow for reduced power consumption by only using the antennas 300 with the most efficient connection with the sensor 102 and correct for altered sensor 102 orientation.

In some embodiments, the array 1000 may be used in any of the transceivers 114 in which an antenna 300 is used. For example, as shown in FIG. 11, the array 1000 may be used in an arm band transceiver 1100. In a non-limiting embodiment, the array 1000 may be positioned, for example, in the main body 1102 of the arm band 1100 or in the strap or band 1104 of the arm band 1100.

FIGS. 12(A)-(C) are a top view, a side view and a perspective view, respectively, of a flat transceiver antenna 1200 embodying aspects of the present invention. The flat transceiver antenna 1200 may include a substrate 1202, antenna coils 1204, a first end 1206, and a second end 1208 of substrate 1202. The flat transceiver antenna 1200 may be the same as the antenna 300 described above except the first end 1206 and the second end 1208 may be bent downwardly and generally towards each other such that the antenna 1200 is approximately U-shaped. In some embodiments, the first end 1206 and the second end 1208 may be bent such that they point approximately in the direction of the sensor 102 when the transceiver 114 is positioned to communicate with the sensor 102. The U-shape may focus the magnetic field in the direction of the bent ends 1206 and 1208, which may create a more effective power transfer and increase communication to the sensor 102.

FIG. 13 is an exploded view of a transceiver including an antenna 1308 embodying aspects of the present invention. The antenna 1308 may be any of the flat antennas 300 or arrays of antennas 1000 described above. In some embodiments, the transceiver may include an integrated circuit 1301. The integrated circuit 1301 may be specific to the transceiver and may include a tuning system, which will compensate for detuning caused by any bending of the flexible antenna 1308.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, the array of antennas may include antennas with bent ends. The antennas in the array could be configured such that the bend ends for each antenna is configured to focus the antenna's magnetic field in a different direction than the other antennas in the array. In addition, although examples of sensor systems having passive sensors are described, this invention is also applicable to sensor systems having active or partially active sensors.

We claim:

1. A system for detecting an analyte, comprising:
a sensor including a sensor antenna;
a transceiver including a transceiver antenna configured to couple with said sensor antenna such that said transceiver antenna supplies power to said sensor antenna and transmits and receives information,
wherein said transceiver antenna includes a coil having a cross section including a height and a width, and the height of the coil is smaller than half the size of the width.

2. The system of claim 1, wherein the cross section of the coil is oval shaped.

3. The system of claim 1, wherein the height of the coil is smaller than one-fifth the size of the width.

4. The system of claim 3, wherein the height of the coil is one tenth the width of the coil.

5. The system of claim 3, wherein the height of the coil is one-seventeenth the size of the width.

6. A transceiver configured to power and communicate with a sensor, comprising:
a housing;
a power source; and
at least one antenna including a coil having a cross section including a height and a width, and the height of the coil is smaller than half the size of the width of the coil.

7. The transceiver of claim 6, wherein the cross section of the coil is approximately oval shaped.

8. The transceiver of claim 6, wherein the height of the coil is at least one-fifth the size of the width of the coil.

9. The transceiver of claim 6, wherein the height of the coil is one tenth of the width of the coil or smaller.

10. The transceiver of claim 6, wherein the transceiver includes a plurality of antennas, each of the plurality of antennas including a coil having a cross section with a width smaller than a height, and said plurality of antennas are positioned directly adjacent each other.

11. The transceiver of claim 10, wherein said transceiver includes a controller configured to determine a strength of connection between each antenna of the plurality of antennas and a sensor.

12. The transceiver of claim 11, wherein said controller is configured to supply power only to the antennas of the plurality of antennas with a connection strength that is above a threshold.

13. The transceiver of claim 6, wherein said antenna includes a substrate, and the coil is mounted on the substrate.

14. The transceiver of claim 13, wherein the substrate includes a first end and a second end, and the first end and the second end are bent downwardly.

15. The transceiver of claim 14, wherein the substrate is approximately U-shaped.

16. The transceiver of claim 13, wherein the substrate is flexible.

17. The transceiver of claim 6, wherein the transceiver includes a plurality of antennas, and said plurality of antennas are positioned in an array.
